(19) United States
(12) Patent Application Publication
(10) Pub. No.: US 2002/0138661 A1
(43) Pub. Date: Sep. 26, 2002

(54) Thread locking

(76) Inventor: Andrew Hayward, Wallingford (GB)

Correspondence Address: MORGAN & FINNEGAN, L.L.P., 345 PARK AVENUE, NEW YORK, NY, 10154, US

(21) Appl. No.: 10/094,302

(22) Filed: Mar. 8, 2002

Related U.S. Application Data
(63) Continuation of application No. PCT/GB00/03236, filed on Aug. 18, 2000.

(30) Foreign Application Priority Data
Sep. 14, 1999 (GB) 9921719.2

(51) Int. Cl. G06F 9/44; G06F 9/00

(52) U.S. Cl. 709/315; 709/107

(57) ABSTRACT

The invention relates to a method of providing thread locking within a multi-threading object-oriented computer program. Each object (400, 500, 600) includes a reserved lock word which is initially set to zero to indicate that the object is unlocked. When the object is to be locked, the word is changed to a pointer (630) which points to a particular memory block (710) within a separate lock pool (700). That memory block contains all the necessary locking information for the object. When the object is to be unlocked, the pointer (630) is deleted, and the lock word set back to zero. The corresponding block (710) in the lock pool is then released, and may be reused for other locking information or for other data that may be required to be stored by the executing application.

This is a continuation of International Application PCT/GB00/03236 with an international filing date of Aug. 18, 2000, published in English under PCT article 21(2).

The present invention relates to thread locking in a multi-threaded environment, and in particular to multi-threaded object-oriented systems.

Programming languages which are object-oriented and which have a multi-threading capability are well-known. One example of such a language is Java (trademark of Sun Microsystems Inc.). In a multi-threaded environment, threads share the same code and memory. This can cause a synchronization problem, and care has to be taken to ensure that two threads are not trying to make changes to the same memory location. In order to deal with this problem, Java (and indeed most other object-oriented languages) requires that each object has a lock associated with it. When a thread which can cause a synchronisation problem is to invoke a method of an object, the state of that object's lock is tested. If it is locked, the thread waits until the lock becomes unlocked. If the object is unlocked, the lock is locked, the method is invoked, and when the method is completed the lock is unlocked.

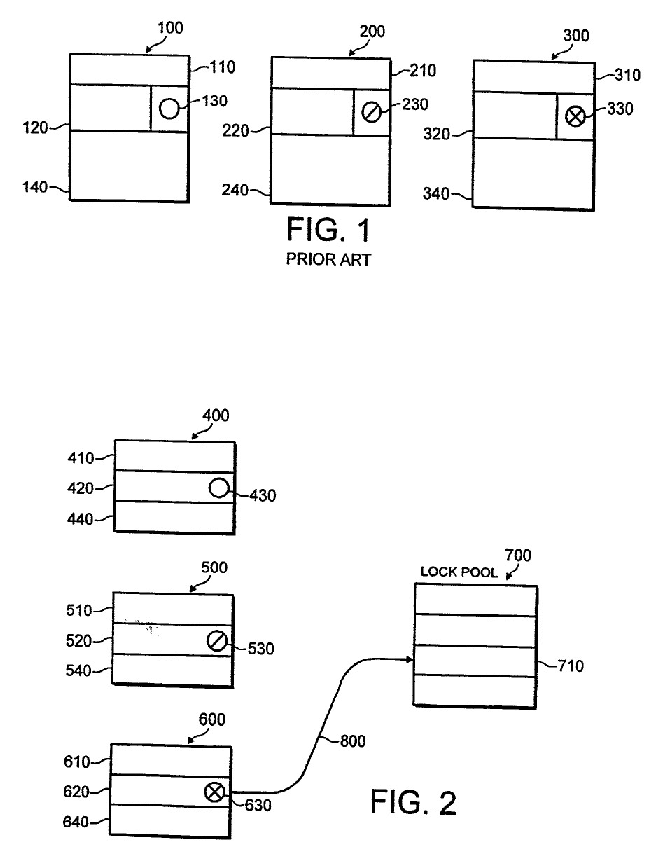

A typical prior art Java implementation is shown schematically in FIG. 1. Each individual object 100, 200, 300 has a respective header 110, 210, 310 and a respective lock block 120, 220, 320. The rest of the object (executable code, data and so on) is shown schematically by the respective blocks 140, 240, 340. Although the lock blocks are shown immediately following the header, they could in fact be located anywhere within the object.

Each lock block 120, 220, 320 reserves space within the object which is used to store locking information about that object, for example the lock status, who has the lock, how many times the lock has been applied, and so on. Part of that block is reserved for lock status information which is shown symbolically in the Figure. The object 100 is never locked, as indicated by the symbol 130, the object 200 is unlocked, as indicated by the symbol 230, and the object 300 is locked, as indicated by the symbol 330.

With such an arrangement, each object needs to reserve a substantial amount of memory space (for example 64 bytes), whether the lock is actually in use or not. When a large number of objects are being held in memory at any one time, the aggregate amount of memory that needs to be reserved for locks can be large. This poses a problem particularly where the object-oriented program is being used in an embedded environment, such as within a mobile telephone, where memory space may be severely limited. Not only is the amount of memory which has to be reserved for the locks large, that amount is fixed and effectively amounts to an “overhead”, whether or not it is actually used.

According to the present invention there is provided a method of object locking in a multi-threading, object-based processing system comprising storing locking information for a locked object at a memory location, and maintaining a pointer associated with the locked object which points to the memory location.

By storing the locking information separately from the locked object, memory utilisation can be improved. Less space needs to be maintained for locking information within the object itself; instead, space needs to be provided merely for a single pointer. Typically, although not necessarily, the memory space that is associated with the object will be a single word which is stored as part of the object itself.

Preferably, the object may be unlocked by resetting the pointer (for example by changing its value to zero) and releasing the memory location for other uses. In one embodiment, a certain section of memory may be reserved exclusively for locking information; alternatively, in another embodiment, any memory that is released may be made available for the storage of other data that may be required by the executing application.

Preferably, each memory location comprises a contiguous memory block, with the individual blocks making up a contiguous lock pool.

The invention further extends to a computer program for effecting a method as previously described, to a data carrier carrying such a computer program, and to a data stream which is representative of such a computer program.

According to another aspect of the invention there is provided a multithreading, object-based computer system comprising means for storing locking information for a locked object at a memory location, and means for maintaining a pointer associated with the locked object which points to the memory location.

The invention may be carried into practice in various ways and one specific embodiment will now be described, by way of example, with reference to the accompanying Figures in which:

FIG. 1 is a schematic diagram showing a typical prior art locking implementation; and

FIG. 2 is a locking implementation according to the preferred embodiment of the present invention.

In the preferred embodiment, shown in FIG. 2, each individual object 400, 500, 600 has a respective header 410, 510, 610. Between the header and the rest of the object 440, 540, 640 a single word 420, 520, 620 is reserved for locking information. When the object is never to be locked, as indicated at 430, the word is set to a specific predefined value. When the object is unlocked, as indicated at 530, the word is set to a different predefined value. These values might be 1 and 0, respectively, although the exact numbers do not matter: all that is required is for the thread reading the word 420 to realise that the object 400 is never locked, and for a thread reading the word 520 to realise that the object 500 is unlocked.

When an object is required to be locked, the lock word is changed from its original value 530 to a new value 630 which represents a pointer to a specific memory location 710 within a separate lock pool 700. This is indicated by the arrow 800. The memory block 710 contains the locking information for the block 600, for example information on who has the lock, how many times the lock has been used and so on. In the preferred implementation, there need be no specific coded indication either within the word 620 or within the memory block 710 to show that the lock is on: the fact that the lock is on is implied merely by virtue of the fact that the word 620 contains a pointer rather than the fixed predefined unlocked/never-locked values 530, 430.

The lock pool 700 is preferably dynamic, with additional memory blocks 710 being reserved only as and when required, or in other words when a lock is to be set on. While the lock pool preferably consists of a series of contiguous memory blocks, that is not essential and non-contiguous memory areas could be used if desired.

In operation, when a new object is created the lock word is initially set to the never-locked value 430 or the unlocked value 530 depending upon the object. When a thread wishes to use the object, it tests whether the object is already locked. Assuming it is unlocked, it reserves a memory location 710 within the lock pool for the necessary locking information, and changes the lock word to a pointer 630 to that location. Once the invoked method has been completed, the lock word is changed back to its unlocked value 530, and the memory block 710 is released. That block 710 then becomes available for reuse by another lock. Alternatively or additionally, in one embodiment, the memory block 710 is not reserved purely for locking information, and may be made available for the storage of any other data that the executing application may require.

It will be appreciated of course that the amount of memory that needs to be reserved within each object is extremely small when compared with the amount required by the prior art implementation. In the preferred embodiment, only a single word (8 bytes) is reserved within each object, compared with typically 64 bytes per object in the prior art. The amount of memory required per object can in the present invention be made as small as possible, consistent with the need to store a pointer addressed to a location within the lock pool.

1. A method of object locking in a multi-threading, object-based processing system comprising storing locking information for a locked object at a memory location, and maintaining a pointer associated with the locked object which points to the memory location.

2. A method as claimed in claim 1 in which the pointer is stored as part of the locked object.

3. A method as claimed in claim 1 or claim 2 in which the object is unlocked by resetting the pointer and releasing the memory location.

4. A method as claimed in claim 3 in which the memory location is, when released, made available for storing locking information relating to other objects.

5. A method as claimed in claim 3 or claim 4 in which the memory location is, when released, made available for the storage of other data.

6. A method as claimed in any one of the preceding claims in which the object maintains an associated pointer location, the pointer location containing the pointer if the object is locked and containing a non-pointer value if the object is unlocked.

7. A method as claimed in claim 6 in which the non-pointer value is zero.

8. A method as claimed in claim 6 or claim 7 in which the pointer location contains a second non-pointer value if the object is never to be locked.

9. A method as claimed in any one of the preceding claims including a plurality of locked objects and associated memory locations, the memory locations defining a lock-pool.

10. A method as claimed in claim 9 in which the memory locations of the lock pool are contiguous.

11. A method as claimed in claim 1 in which the memory location comprises a contiguous memory block.

12. A computer program for effecting a method as claimed in any one of claims 1 to 11.

13. A data carrier carrying a computer program as claimed in claim 12.

14. A data stream representative of a computer program as claimed in claim 12.

15. A multi-threading, object-based computer system comprising means for storing locking information for a locked object at a memory location, and means for maintaining a pointer associated with the locked object which points to the memory location.

16. A computer system as claimed in claim 15 including means for maintaining a pointer location associated with the object.

17. A computer system as claimed in claim 16 including means for determining that the object is locked if the pointer location contains a pointer.

18. A computer system as claimed in claim 16 or claim 17 including means for determining that the object is unlocked if the pointer location contains a non-pointer value.
